(19) United States
(12) Patent Application Publication
(10) Pub. No.: US 2016/0098336 A1
(43) Pub. Date: Apr. 7, 2016

(54) METHODS AND SYSTEMS FOR DYNAMIC RETIMER PROGRAMMING

(71) Applicant: NETAPP. INC., Sunnyvale, CA (US)

(72) Inventors: Michael M. Loebig, Cranberry Township, PA (US); Madhu Bindu Ankem Venkata, Morrisville, NC (US); Chen Zhao, Cary, CA (US)

(21) Appl. No.: 14/505,629

(22) Filed: Oct. 3, 2014

(51) Int. Cl. G06F 11/34; G06F 11/30; G06F 13/10

(52) U.S. Cl. CPC G06F 11/3409; G06F 13/10; G06F 11/3027

(57) ABSTRACT

Systems and methods for dynamically programming retimers for computer communications are disclosed. For example, in one aspect, a machine implemented method is disclosed that includes: detecting a cable related event at a port coupled to another device via a cable; determine a cable type and a cable length from a storage location of the port; determining if the cable type and the cable length are different from a previously stored cable type and cable length connecting the port to the other device; and when either the cable type or the cable length are different than the previously stored cable type and cable length, programming a retimer device based on the cable type and length.

### TECHNICAL FIELD

The present disclosure pertains to computer systems, and more particularly to network connection configuration used by such systems.

### BACKGROUND

Computing systems are commonly used today. These computing systems are often networked to be able to share resources, share data, and provide system redundancies. In order to share data, many computing systems are connected to each other through one of several types of cabling, such as copper cables or optical cables. One example of such networked computing systems includes high availability (HA) clusters. These clusters define a collection of computing systems or nodes (typically servers) that operate as if they were a single machine to provide uninterrupted access to data, for example, even if one server loses network or storage connectivity or fails completely. The cable connections between nodes in an HA system—or among computer systems generally—are important to provide consistent, high quality communication signals.

Computer systems generally include ports that allow cables to be connected for communication between two servers, for example. These ports often are controlled by an application-specific integrated circuit (ASIC) that helps manage the signals sent and received by the port over a connected cable. Sometimes, however, an ASIC is not powerful enough to provide optimal signals over a particular cable. In such cases, a retimer (or signal conditioner) is often employed to improve signal strength or quality and provide better communications. Continuous efforts are being made to improve communication between computing systems.

### SUMMARY

In one aspect, a machine implemented method is provided. The method includes detecting a cable related event at a port coupled to another device via a cable; determining a cable type and a cable length from a storage location of the port; determining if the cable type and the cable length are different from a previously stored cable type and cable length connecting the port to the other device; and when either the cable type or the cable length are different than the previously stored cable type and cable length, programming a retimer device based on the cable type and length.

In another aspect, a non-transitory, machine readable storage medium having stored thereon instructions for performing a method is provided. The machine executable code which when executed by at least one machine, causes the machine to: detect a cable related event at a port coupled to another device via a cable; determine a cable type and a cable length from a storage location of the port; determine if the cable type and the cable length are different from a previously stored cable type and cable length connecting the port to the other device; and when either the cable type or the cable length are different than the previously stored cable type and cable length, programming a retimer device based on the cable type and length.

In yet another aspect, a system having a memory containing machine readable medium comprising machine executable code having stored thereon instructions is provided. A processor module coupled to the memory is configured to execute the machine executable code to: detect a cable related event at a port coupled to another device via a cable; determine a cable type and a cable length from a storage location of the port; determine if the cable type and the cable length are different from a previously stored cable type and cable length connecting the port to the other device; and when either the cable type or the cable length are different than the previously stored cable type and cable length, programming a retimer device based on the cable type and length.

This brief summary has been provided so that the nature of this disclosure may be understood quickly. A more complete understanding of the disclosure can be obtained by reference to the following detailed description of the various aspects thereof in connection with the attached drawings.

### BRIEF DESCRIPTION OF THE DRAWINGS

The foregoing features and other features will now be described with reference to the drawings of the various aspects. In the drawings, the same components have the same reference numerals. The illustrated aspects are intended to illustrate, but not to limit the present disclosure. The drawings include the following Figures:

FIG. 1A is a block diagram illustrating an example of a network system, used according to one aspect of the present disclosure;

FIG. 1B is a block diagram illustrating an example of an adapter used according to one aspect of the present disclosure; and

FIG. 2 shows a process flow according to one aspect of the present disclosure.

### DETAILED DESCRIPTION

As a preliminary note, the terms “component”, “module”, “system,” and the like as used in this disclosure are intended to refer to a computer-related entity, either programmable instructions-executing general purpose processor, hardware, firmware and a combination thereof. For example, a component may be, but is not limited to being, a process running on a processor, a processor, an object, an executable, a thread of execution, a program, and/or a computer.

By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, on non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick, flash memory device or any other non-volatile memory device, or any other storage device, in accordance with the claimed subject matter.

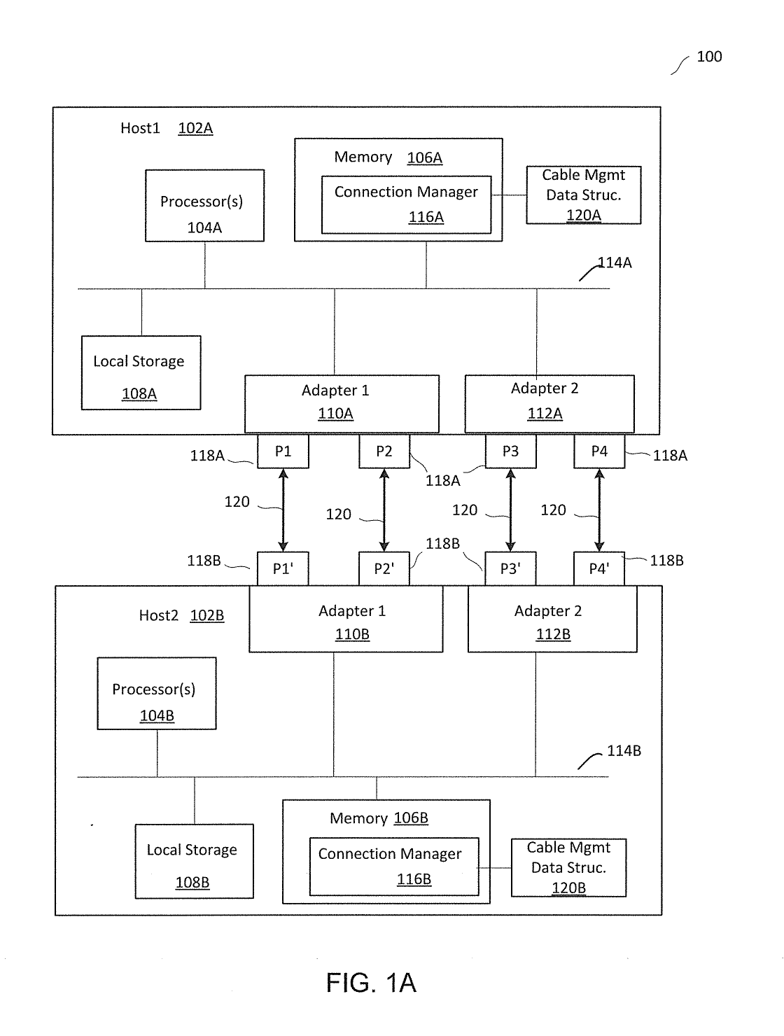

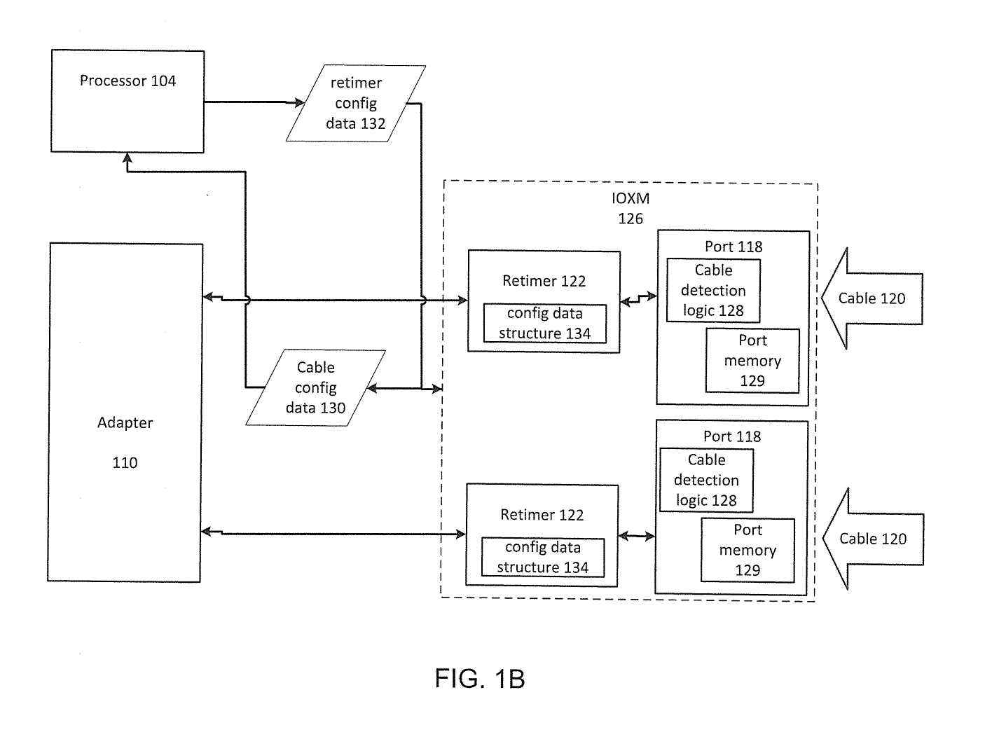

System 100: FIG. 1A is a block diagram illustrating an example network computer system 100 in which the technology introduced herein can be implemented. In one aspect, computer system 100 comprises a HA-Interconnect system, but other system types and configurations are also capable of implementing the teachings herein. The configuration described with respect to FIG. 1A is for illustration of a type of configuration in which the technology described herein can be implemented. As would be recognized by one skilled in the art, other computer network configurations could be used for implementing the technology disclosed herein.

As illustrated in the example of FIG. 1A, system 100 includes a host1 102A (may also be referred to as host 102A) and a host2 102B (may also be referred to as host 102B) that are communicatively connected by one or more cables 120. It is noteworthy that the hosts may be connected to each other via a network or a switch and the direct connection is simply being shown for clarity. Hosts 102A, 102B may also be considered servers 102. Note, certain standard components used by servers 102 that are not germane to the aspects disclosed herein have not been described. It should, of course, be understood that a system 100 may have more than two hosts or servers 102, which may be connected in a variety of ways. As will be understood from the disclosure herein, host 102A and host 102B are illustrated as identical hosts, but other computers, servers, and network appliances may also incorporate the teachings described herein. Also, for simplicity, the description herein will primarily refer to host 102A and its components, but it should be understood that like numbers, whether A or B, indicate like components for the different hosts. Therefore a discussion of, for example, processor 104A should be read to be equally applicable to processor 104B or as it the discussion said “processors 104A, 104B” or the like.

As illustrated, host 102A comprises of processor(s) 104A, memory 106A, local storage 108A, and network adapters 110A, 112A coupled by a bus system 114A. The bus system 114A is an abstraction that represents any one or more separate physical buses and/or point-to-point connections, connected by appropriate bridges, adapters and/or controllers. The bus system 114A, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The one or more processors 104A are the central processing units (CPUs) of the host 102A and, thus, control the overall operation of the host 102A. In certain aspects, the processors 104A accomplish this by executing programmable instructions out of memory 106A. The processors 104A may include one or more programmable general-purpose or special-purpose microprocessors, digital signal processors (DSPs), programmable controllers, application specific integrated circuits (ASICs), programmable logic devices (PLDs), or the like, and/or a combination of such devices.

The memory 106A comprises storage locations that are addressable by the processor(s) 104A and adapters 110A, 112A. The storage locations are able to store executable instructions that preferably include a connection manager 116A. The processor(s) 104A and the adapters 110A, 112A may, in turn, comprise processing elements and/or logic circuitry configured to execute the programmable code and manipulate various data structures (which may also be stored in memory 106A at times). Other software running out of memory 106A may include an operating system and/or applications.

The memory 116A can be a random access memory (RAM), a read-only memory (ROM), or the like, or a combination of such devices. It will be apparent to those skilled in the art that other processing and memory means, including various computer readable media, may be used for storing and executing program instructions pertaining to the aspects described herein.

Host 102A also has access to local storage 108A which comprises one or more mass storage devices that may store information within the host 102A, such as executable instructions (also referred to as software), the server operating system, and/or data. The host 102A loads software into the memory 106A from which it can be accessed by the processors 104A. The local storage 108A may be or may include any conventional medium for storing large volumes of data in a non-volatile manner, such as one or more magnetic or optical based disks, flash memory, hard drives (HDDs), solid state drives (SSDs), hybrid drives (sometimes referred to as SSHDs), and other types of storage devices.

As an example, host 102A includes two network adapters 110A, 112A as illustrated, but it is understood that a host may have more or fewer adapters. In one aspect, each adapter 110A, 112A comprises one or a plurality of ports 118A adapted to couple the host 102A to another host 102B (or multiple other computer systems) over point-to-point links, wide area networks, virtual private networks implemented over a public network (Internet), a shared local area network, or the like. Ports 118A accept cables 120 which are then connected to other hosts, like host 102B. In some aspects, hosts 102 may have one or multiple connections between them.

In one aspect, host 102A includes a connection manager 116A that is a set of instructions that may be executed out of memory 106A. Connection manager 116A may comprise an application, a driver, an operating system function, or the like. In one aspect, connection manager 116A operates to configure connections and store connection parameters used by adapter1 110A (may also be referred to as adapter 110A) and adapter2 112A (adapter 112A) and their ports 118A for performing network communication. In one aspect, the connection manager 116A helps determine settings for the adapters and their ports to provide optimal communications signals as will be described in more detail below. In order to help accomplish these tasks, connection manager 116A may also include or access a cable management data structure 120A, which preferably includes configuration data for ports 118A. Cable management data structure 120A may further include a previous configuration data set and a current configuration data set for comparison purposes as described herein. In one aspect, the cable management data structure 120A also includes a look-up table or other data structures that maps cable properties to settings for aspects of ports 118A.

Turning to FIG. 1B, aspects of host 102A involved in network communications are set forth in more detail. As described above, network adapters 110 may have an ASIC (not shown) which, in some cases, may not provide the desired signal strength for network communications. In such cases, as illustrated, an adapter 110 may include or communicate with one or more retimer devices 122 (or simply retimers) which condition signals for each port to provide more reliable communication across a cable 120. In turn, the retimer 122 sends signals to a port 118 for transmission through a cable 120. Conventional retimers are statically configured, such as by loading configuration data from an electronically erasable programmable read only memory (EEPROM) or similar data storage structure. This is undesirable because when a cable is changed, the retimer configuration remains static and cannot be changed.

As illustrated in FIG. 1B, each port 118 and associated retimer 122 may be included in an input/output extension module (IOXM) 126. IOXM 126 includes components that interface with physical cable 120 to enable network communication. Further each port 118 includes cable detection logic 128 which can determine when a cable 120 is plugged into or unplugged from the port 118. In one aspect, for example, the cable detection logic 128 stores general purpose input/output (GPIO) pin states that change on a cable plugin event. GPIO pins are standard pin provided on connectors of port 118 that are coupled to cable 120.

The port 118 further includes port memory 129 that stores indicators of properties of the cable that is plugged into the port. In one aspect, for example, a port 118 comprises a quad small form-factor pluggable (QSFP) port, and the port memory 129 includes QSFP base and extended registers for storing configuration data. In one aspect, the values of these registers provide an indication of at least a cable type and a cable length for properties of the cable. For example, the cable type may include passive or active copper cabling or passive or active optical cabling. In another aspect, the QSFP base and extended registers may be located on cables 120 themselves and read by port 118′s cable detection logic 128.

In one aspect, cable configuration data 130 (the values of the QSFP base and extended registers, for example) are passed from the port(s) 118 to the processor 104 running connection manager 116 (FIG. 1A). The connection manager 116 then parses the cable configuration data 130 to determine the cable type and cable length. The connection manager 116 then utilizes the cable management data structure 120A (FIG. 1A) and the cable type and length to determine an optimal retimer configuration. Retimer configuration data 132 is then passed to retimer 122 and applied to the retimer's configuration data structure 134 to implement that optimal configuration. With the retimer thus programmed, host 102 is able to send and receive signals through the adapters 110, 112 and ports 118 with more optimal signal processing than the conventional hard-coded retimers.

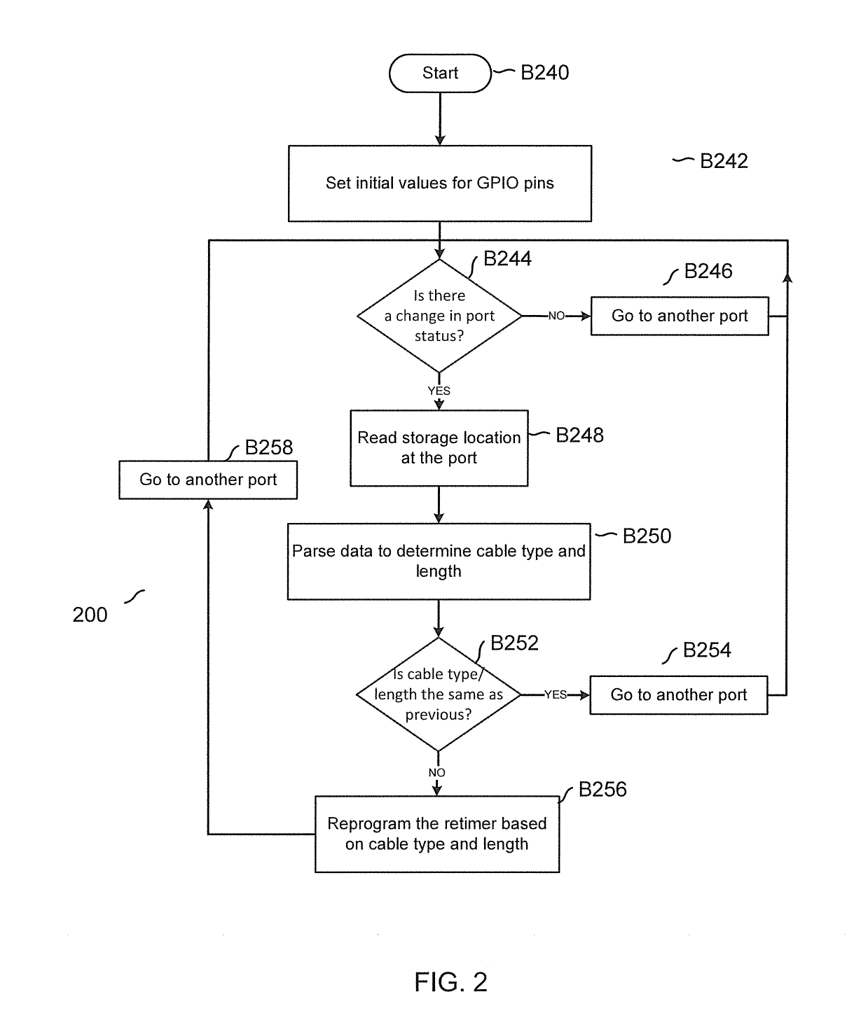

Process: Turning to FIG. 2, a process flow 200 sets forth the retimer device dynamic programming process, according to one aspect. The process flow 200 starts at block B240, with a host 102 that includes at least one adapter 110 communicating with a retimer 122 and port 118, the host executing a connection manager 116. At block B242, the connection manager 116 reads values from the cable management data structure 120 and sets initial cable connection values. In one aspect, these are initial GPIO pin values.

At block B244, the connection manager 116 selects a port 118, and it polls the cable detection logic 128 of the port 118 to determine if there has been a change in state of the connection values. If there has not been a change of status, the connection manager 116 selects another port at block B246 and restarts the process.

If there has been a change in status, this indicates a cable plugin event, and, at block B248, the port memory 129 is read to obtain cable configuration data 130. As described above, in one aspect, this may include reading QSFP registers. More specifically, in one aspect, the cable configuration data may be read through an inter-integrated circuit (I2C) interface command. I2C is a standard bus/interface used for communicating with peripheral devices, for example, IOXM 126.

At block B250, the connection manager parses the cable configuration data 130 to determine a cable type and a cable length. This process may include using a look-up table or other aspect of the cable management data structure 120.

At block B252, the determined cable type and cable length are compared to data for the previously found cable type and length (which may also be stored in the cable management data structure 120). If the cable type and cable length are the same as previous, then the retimer 122 already is properly configured and no changes need to be made. In this case, the process continues to block B254, where another port is selected for testing.

If either the cable length or the cable type are different than previously detected, the process continues to block B256, where the connection manager 116 determines appropriate retimer configuration data 132. In one aspect, the cable type and cable length may be used to parse a look-up table or matrix in the cable management data structure 120 to find this configuration data. The connection manager 116 passes this data to the retimer 122 (in one aspect, this is done through an I2C command), which stores the retimer configuration data 132 in the configuration data structure 134. The retimer 122 operates based on these configuration settings stored in the configuration data structure 134. In one aspect, for example, the configuration data structure comprises retimer registers. At block B258, the connection manager 116 selects another port to test and restarts the process.

In various aspects, the process may cycle through each port and then restart with the first port immediately, after a time delay, when system resources allow, combinations of the same, and the like. By way of example, the process may be run as a module to monitor the link status of the port (whether a cable is attached or detached) as a background process, and it may periodically wake-up to check the status the ports.

In another aspect, the connection manager may determine that the cable configuration data 130 indicates an “unsupported” cable and may disable the associated port 118 or its external link until a supported cable is plugged in. In one aspect, the connection manager 116 may report an error message, such as to a system administrator. In this manner, a system administrator may be able to quickly determine whether or not a cable will provide adequate communications fidelity with the retimer 112 and port 118 setup.

The processes described herein are organized as sequences of operations in the flowcharts. However, it should be understood that at least some of the operations associated with these processes potentially can be reordered, supplemented, or substituted for, while still performing the same overall technique.

The technology introduced above can be implemented by programmable circuitry programmed or configured by software and/or firmware, or they can be implemented entirely by special-purpose “hardwired” circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware for implementing the technology introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, or any device with one or more processors, etc.). For example, a machine-accessible medium includes recordable/non-recordable media. (e.g., read-only memory (ROM); random access memory (RAM); magnetic disk storage media; optical storage media; flash memory devices; etc.), etc. The term “logic”, as used herein, can include, for example, special-purpose hardwired circuitry, software and/or firmware in conjunction with programmable circuitry, or a combination thereof.

While the present disclosure is described above with respect to what is currently considered its preferred aspects, it is to be understood that the disclosure is not limited to that described above. To the contrary, the disclosure is intended to cover various modifications and equivalent arrangements within the spirit and scope of the appended claims. For example, and without limiting the forgoing, data structures and memory herein, such as configuration data structure 134, port memory 129, and the like are described in examples as registers, but other memory and data structures may also be used in implementations, such as EEPROMs, RAM, flash memory, or the like. Additionally, the layouts described herein are exemplary only, and components and modules described herein may be combined or arranged in different ways without departing from the spirit of the present disclosure. For example, retimers 122 may be included as part of adapters 110, 112 or ports 118. Other arrangements and modifications will be apparent to those of skill in the art from the disclosure herein.

What is claimed is:

1. A machine implemented method, comprising:
detecting a cable related event at a port coupled to another device via a cable;
determining a cable type and a cable length from a storage location of the port;
determining if the cable type and the cable length are different from a previously stored cable type and cable length connecting the port to the other device; and
when either the cable type or the cable length are different than the previously stored cable type and cable length, programming a retimer device based on the cable type and length.

2. The machine implemented method of claim 1, wherein programming the retimer device comprises setting values in a retimer register or retimer electronically erasable programmable read only memory (EEPROM).

3. The machine implemented method of claim 1, wherein programming a retimer comprises using a look-up table based on the cable type and the cable length to determine appropriate retimer settings.

4. The machine implemented method of claim 1, wherein the storage location for the port comprises Quad Small Form-Factor Pluggable (QSFP) registers.

5. The machine implemented method of claim 1, wherein detecting a cable plug event comprises:
setting an initial value for a general purpose input/output (GPIO) pin;
reading a GPIO pin state for the port; and
determining if the GPIO pin state is different from the initial value.

6. The machine implemented method of claim 1, wherein programming settings of a retimer comprises using an inter-integrated circuit (I2C) write command to write to at least one retimer register.

7. The machine implemented method of claim 1, wherein the cable type indicates an optical cable, a passive copper cable, or an active copper cable.

8. A non-transitory, machine readable storage medium having stored thereon instructions for performing a method, comprising machine executable code which when executed by at least one machine, causes the machine to:
detect a cable related event at a port coupled to another device via a cable;
determine a cable type and a cable length from a storage location of the port;
determine if the cable type and the cable length are different from a previously stored cable type and cable length connecting the port to the other device; and
when either the cable type or the cable length are different than the previously stored cable type and cable length, programming a retimer device based on the cable type and length.

9. The machine readable storage medium of claim 8, wherein the instructions to program the retimer device comprise instructions to set values in a retimer register or retimer EEPROM.

10. The machine readable storage medium of claim 8, wherein the instructions to program the retimer device comprise instructions to use a look-up table based on the cable type and the cable length to determine appropriate retimer settings.

11. The machine readable storage medium of claim 8, wherein the storage location for the port comprises QSFP registers.

12. The machine readable storage medium of claim 8, wherein the instructions to detect a cable plug event comprise instructions to:
set an initial value for a GPIO pin;
read a GPIO pin state for the port; and
determine if the GPIO pin state is different from the initial value.

13. The machine readable storage medium of claim 8, wherein programming settings of a retimer comprises using an I2C write command to write to at least one retimer register.

14. The machine readable storage medium of claim 8, wherein the cable type indicates an optical cable, a passive copper cable, or an active copper cable.

15. A system, comprising:
a memory containing machine readable medium comprising machine executable code having stored thereon instructions;
and a processor module coupled to the memory, the processor module configured to execute the machine executable code to:
detect a cable related event at a port coupled to another device via a cable;
determine a cable type and a cable length from a storage location of the port;
determine if the cable type and the cable length are different from a previously stored cable type and cable length connecting the port to the other device; and
when either the cable type or the cable length are different than the previously stored cable type and cable length, programming a retimer device based on the cable type and length.

16. The system of claim 15, wherein the code to program the retimer device comprises code to set values in a retimer register or retimer EEPROM.

17. The system of claim 15, wherein the code to program the retimer device comprises code to use a look-up table based on the cable type and the cable length to determine appropriate retimer settings.

18. The system of claim 15, wherein the storage location for the port comprises QSFP registers.

19. The system of claim 15, wherein the code to detect a cable plug event comprises code to:
set an initial value for a GPIO pin;
read a GPIO pin state for the port; and
determine if the GPIO pin state is different from the initial value.

20. The system of claim 15, wherein the cable type indicates an optical cable, a passive copper cable, or an active copper cable.
